(19) United States
(12) Patent Application Publication
(10) Pub. No.: US 2026/0112518 A1
(43) Pub. Date: Apr. 23, 2026

(54) ELECTRICALLY CONDUCTIVE AND OPTICALLY TRANSPARENT WINDOW AND ASSOCIATED QUBIT QUANTUM OBJECT CONFINEMENT APPARATUS

(71) Applicant: Quantinuum LLC, Broomfield, CO (US)

(72) Inventors: David A. DEEN, Edina, MN (US); Todd Michael KLEIN, Wayzata, MN (US); Christopher T. ERTSGAARD, Champlin, MN (US)

(21) Appl. No.: 19/365,385

(22) Filed: Oct. 22, 2025

Related U.S. Application Data
(60) Provisional application No. 63/710,285, filed on Oct. 22, 2024.

(51) Int. Cl. G21K 1/00

(52) U.S. Cl. CPC G21K 1/30

(57) ABSTRACT

An electrically conductive and optically transparent window comprises a transparent conductive layer (TCL) and a first cladding layer applied to the TCL. A material and a thickness of the first cladding layer are selected to increase the conductivity of the window as compared to an electrically conductive and optically transparent window comprising the TCL without a cladding layer.

### CROSS-REFERENCE TO RELATED APPLICATIONS

This application claims priority to and the benefit of U.S. Provisional Patent Application Ser. No. 63/710,285, filed on Oct. 22, 2024 and titled “ELECTRICALLY CONDUCTIVE AND OPTICALLY TRANSPARENT WINDOW AND ASSOCIATED ATOMIC OBJECT CONFINEMENT APPARATUS,” which is incorporated herein by reference in its entirety.

### TECHNICAL FIELD

Various embodiments relate generally to qubit quantum object confinement apparatuses, and more particularly to optical heterojunction windows for surface electrodes of a qubit quantum object confinement apparatus.

### BACKGROUND

Qubit quantum object confinement apparatuses are used to confine or trap qubit quantum objects, such as atoms, ions, molecules, and/or the like. Precise control of confined ions, using an ion trap that comprises metallic electrodes that can be driven to specific voltages as required, requires shielding spurious and unintended electromagnetic fields from the local environment. This becomes challenging in the context of integrated photonics because some of the electrodes will contain optically transparent and electrically conductive materials.

Through applied effort, ingenuity, and innovation many deficiencies of such qubit quantum object confinement apparatuses have been solved by developing solutions that are structured in accordance with the embodiments of the present invention, many examples of which are described in detail herein.

### BRIEF SUMMARY OF EXAMPLE EMBODIMENTS

Example embodiments provide electrically conductive and optically transparent windows, qubit quantum object confinement apparatuses, systems comprising qubit quantum object confinement apparatuses such as quantum computers, and methods for fabricating qubit quantum object confinement apparatuses. According to a first aspect, an electrically conductive and optically transparent window is provided. In an example embodiment, the electrically conductive and optically transparent window comprises a transparent conductive layer (TCL) and a first cladding layer applied to the TCL. A material and a thickness of the first cladding layer are selected to increase the conductivity of the window as compared to an electrically conductive and optically transparent window comprising the TCL without a cladding layer.

In an example embodiment, the electrically conductive and optically transparent window further comprises an antireflective layer stack. A number of layers, a material of each layer, and a thickness of each layer of the antireflective layer stack are selected to balance high optical transmission and low reflected power.

In an example embodiment, the antireflective layer stack is applied to the TCL opposite the first cladding layer.

In an example embodiment, the antireflective layer stack is applied to the first cladding layer opposite the TCL.

In an example embodiment, the electrically conductive and optically transparent window further comprises a second cladding layer applied to the TCL opposite the first cladding layer. A material and a thickness of the second cladding layer are selected to increase the conductivity of the window as compared to an electrically conductive and optically transparent window comprising the TCL and the first cladding layer without a second cladding layer.

In an example embodiment, the first and second cladding layers comprise one or more of indium tin oxide, aluminum-doped zinc oxide, aluminum oxide, silicon nitride, aluminum nitride, silicon dioxide, silicon, or gold.

In an example embodiment, the first cladding layer has a lower relative permittivity than a permittivity of the TCL.

In an example embodiment, the first cladding layer has a higher relative permittivity than a permittivity of the TCL.

In an example embodiment, an effective bandgap of the first cladding layer is larger than an effective bandgap of the TCL such that an electronic mode confinement is created by the first cladding layer at an interface between the first cladding layer and the TCL.

In an example embodiment, the TCL comprises a transparent conductive oxide (TCO).

According to another aspect, an electrically conductive and optically transparent window is provided. In an example embodiment, the electrically conductive and optically transparent window comprises a transparent conductive layer (TCL) and an antireflective layer stack. A number of layers, a material of each layer, and a thickness of each layer of the antireflective layer stack are selected to balance high optical transmission and low reflected power and are selected to increase the conductivity of the window as compared to an electrically conductive and optically transparent window comprising the TCL without an antireflective layer stack.

According to another aspect, a qubit quantum object confinement apparatus is provided. In an example embodiment, the qubit quantum object confinement apparatus comprises a substrate, a plurality of electrodes disposed on a surface of the substrate, and at least one electrically conductive and optically transparent window as described above spanning an opening defined in a corresponding one of the plurality of electrodes.

According to another aspect, a quantum computer is provided. In an example embodiment, the quantum computer comprises a qubit quantum object confinement apparatus as described above, at least one manipulation source configured to provide a manipulation signal, and a controller configured to control operation of the qubit quantum object confinement apparatus to cause the qubit quantum object confinement apparatus to confine one or more qubit quantum objects. The controller is further configured to control operation of the at least one manipulation source to cause the manipulation signal to be incident on a qubit quantum object of the one or more qubit quantum objects via the at least one electrically conductive and optically transparent window.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising a qubit quantum object confinement apparatus, in accordance with an example embodiment.

FIG. 2 provides a top view of at least a portion of an example qubit quantum object confinement apparatus, in accordance with an example embodiment.

FIGS. 3A, 3B, and 3C illustrate cross-sections of at least a portion of an example qubit quantum object confinement apparatus, in accordance with various embodiments.

FIGS. 4A-C, and 5A-C illustrate various properties of an example electrically conductive and optically transparent window, in accordance with various embodiments.

FIG. 6 provides a schematic diagram of an example controller of a system comprising a quantum object confinement apparatus configured for confining qubit quantum objects therein, in accordance with an example embodiment.

FIG. 7 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, qubit quantum objects are confined by a qubit quantum object confinement apparatus (also referred to as a confinement apparatus herein). In various embodiments, a qubit quantum object is an ion; atom; ionic, molecular, and/or multipolar molecule; quantum dot; quantum particle; group, crystal, and/or combination thereof (e.g., an ion crystal comprising two or more ions); and/or the like. In an example embodiment where the qubit quantum objects are ions and/or ion crystals, the confinement apparatus is an ion trap, such as a surface ion trap, Paul ion trap, and/or the like. In various other embodiments, the confinement apparatus is an apparatus configured to confine qubit quantum objects and comprises a plurality of surface electrodes. (In this regard, such confinement apparatuses are referred to herein as ion traps.) For example, in various embodiments, the confinement apparatus comprises a substrate that may include one or more layers including one or more vias, metal routing and/or interconnect layers, photonic/optical layers, and/or the like. A plurality of surface electrodes is formed on the substrate.

In various embodiments, the qubit quantum objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, and/or the like.

In various embodiments, the use of integrated photonics requires that some of the electrodes must be made of transparent materials, while still providing shielding of spurious and unintended electromagnetic fields from the local environment. In various embodiments, a transparent conductive layer (TCL) provide optical transparency for impinging light while simultaneously screening spurious electric fields. These attributes are provided by the wide energy band gap of the TCL that provides transmission across a wide wavelength range and semiconductor-level mobile charge density.

In various embodiments, the conductive properties of the TCL are enhanced by cladding the TCL with a wide band gap, high conduction band discontinuity material. The effective band gap of the cladding should be larger than that of the TCL and the cladding should also have a lower relative permittivity than the TCL itself. In various embodiments, the layered structure (TCL/cladding) is further layered with an antireflective coating. In various embodiments, the cladding layer itself has antireflective properties. Such layered structures of heterogenous materials may be termed optical heterojunction windows.

In some embodiments, the TCL is a transparent conductive oxide (TCO), although other transparent conductive films may be used. In various embodiments, any suitable TCO may be used, such as but not limited to indium tin oxide (ITO) or aluminum-doped zinc oxide (AZO).

In various embodiments, the TCL performs two functions simultaneously: the first function is to screen spurious electric fields that arise from various sources, and the second function is to be transparent to a spectrum of wavelengths of light that are to be passed through the window. To increase conductivity and thereby improve the screening of spurious electric fields using only the TCL would require increasing the thickness of the TCL which would decrease the transparency. Thus, in various embodiments, carefully selected cladding material(s) is added to one or both sides of the TCL to improve the conductivity of the TCL. In various embodiments, the cladding layers are much thinner than the TCL (which itself is quite thin) such that the increased conductivity is provided with little or no reduction in the optical transparency of the window.

In various embodiments, the resistance of the TCL is decreased and the conductivity of the TCL is increased by carefully selecting the materials of the cladding layer(s) and the TCL what causes the conduction mode to be “squeezed” according to the electrostatics of the cladding layers and the TCL. Generally, the conduction mode tails interact with the surface of a thin film and the interaction causes more resistance via specular surface and interface roughness scattering. However, in various embodiments, by carefully selecting the materials of the cladding layer(s) and the TCL, that interaction at the surface is affected and suppressed by squeezing the conduction mode. In this regard, the physical thinness of the TCL can be maintained with only a very thin cladding layer (or layers) that will make the TCL look electrically like a thicker film and optically like a thin film.

In various embodiments, an anti-reflective (AR) layer stack (i.e., a stack of two or more layers of two or more materials that, together, provide AR properties) is applied to the TCL. In some embodiments, the AR layer stack applied directly to the TCL. In some other embodiments, the AR layer stack is applied to a cladding layer that is applied to the TCL.

In various embodiments, the cladding material(s) and thickness(es) and the AR layer stack material(s) and thickness(es) are selected at the same time (i.e., co-designed) with the goal of both maximizing the electrical properties as well as the optical transmission.

Various embodiments of the present disclosure provide optical heterojunction windows, confinement apparatuses having optical heterojunction windows, systems that include such confinement apparatuses, and methods for manufacturing such confinement apparatuses.

### Exemplary System Comprising a Qubit Quantum Object Confinement Apparatus

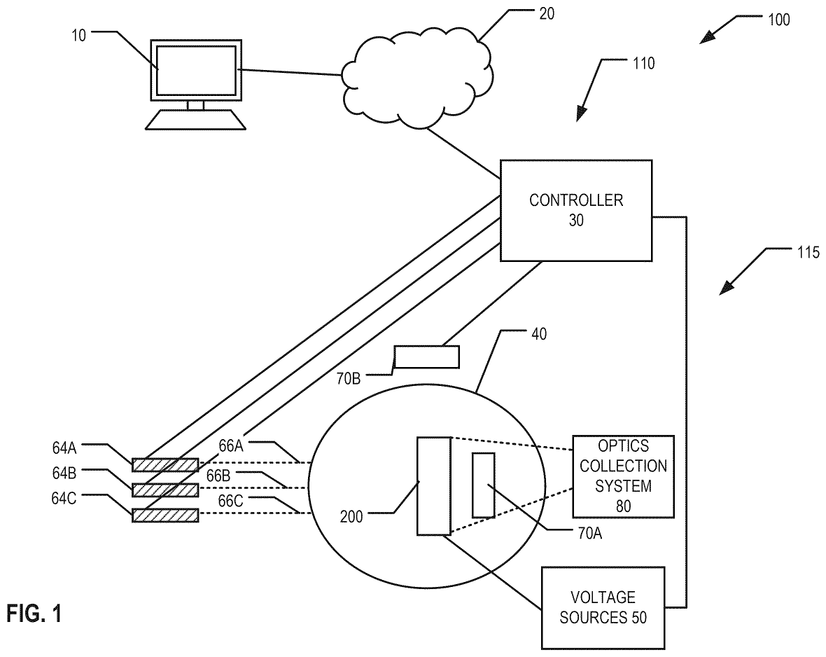

As noted above, various confinement apparatuses of various embodiments may be incorporated into various atomic systems, quantum systems, and/or the like. For example, various embodiments provide a system 100 comprising a qubit quantum object confinement apparatus 200, as shown in FIG. 1. The qubit quantum object confinement apparatus 200 is configured to confine a plurality of qubit quantum objects such that the respective quantum states of the qubit quantum objects may be manipulated, evolved in a controlled manner (e.g., in accordance with a quantum circuit), and/or the like.

For example, qubit quantum objects may be used as the qubits of a quantum computer 110. For example, quantum operations (one qubit quantum logic gates, two qubit quantum logic gates, initialization, reading/detecting operations, and/or the like) may be performed on qubit quantum objects confined by the confinement apparatus 200 and/or system 100 comprising the confinement apparatus. For example, the confinement apparatus 200 is configured to maintain one or more qubit quantum objects at respective locations and/or transport qubit quantum objects between respective locations such that the quantum operation may be performed on the one or more qubit quantum objects.

In various embodiments, the system 100 comprising the confinement apparatus 200 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more qubit quantum objects confined at particular locations defined at least in part by the confinement apparatus. In various embodiments, the system 100 comprising the confinement apparatus 200 comprises one or more magnetic field sources 70 (e.g., 70A, 70B) configured to provide a controlled magnetic field and/or magnetic field gradient at particular locations defined at least in part by the confinement apparatus for use in performing one or more quantum operations on one or more qubit quantum objects confined by the confinement apparatus 200. In various embodiments, the system 100 comprising the confinement apparatus 200 comprises an optics collection system configured to collect and/or detect light and/or photons emitted by one or more qubit quantum objects disposed at the particular locations defined at least in part by the confinement apparatus.

In an example embodiment, the system 100 comprising the confinement apparatus 200 is and/or includes a quantum charge-coupled device (QCCD)-based quantum computer 110. For example, one or more of the qubit quantum objects confined by the confinement apparatus 200 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement apparatus 200, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more qubit quantum objects confined by the confinement apparatus 200. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on qubit quantum objects confined by the confinement apparatus.

In an example embodiment, the one or more manipulation sources 64 each provide a manipulation signal (e.g., laser beam and/or the like) to one or more regions of the qubit quantum object confinement apparatus 200 via corresponding beam path systems 66 (e.g., 66A, 66B, 66C). In various embodiments, at least one beam path system 66 comprises a modulator configured to modulate the manipulation signal being provided to the confinement apparatus 200 via the beam path system 66. In various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. In an example embodiment, a beam path system 66 includes one or more optical fibers configured to transport manipulation signals at least partially from a manipulation source 64 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus). In various embodiments, the manipulation sources 64, modulator, and/or other components of the quantum computer 110 are controlled by the controller 30.

In various embodiments, the confinement apparatus 200 is an ion trap, such as a surface ion trap, Paul ion trap, and/or the like. In various embodiments, the qubit quantum objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 200 is an appropriate confinement apparatus for confining the qubit quantum objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 200, in an example embodiment.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more regions of the confinement apparatus 200 that has a particular magnitude and a particular magnetic field direction in the one or more regions of the confinement apparatus 200.

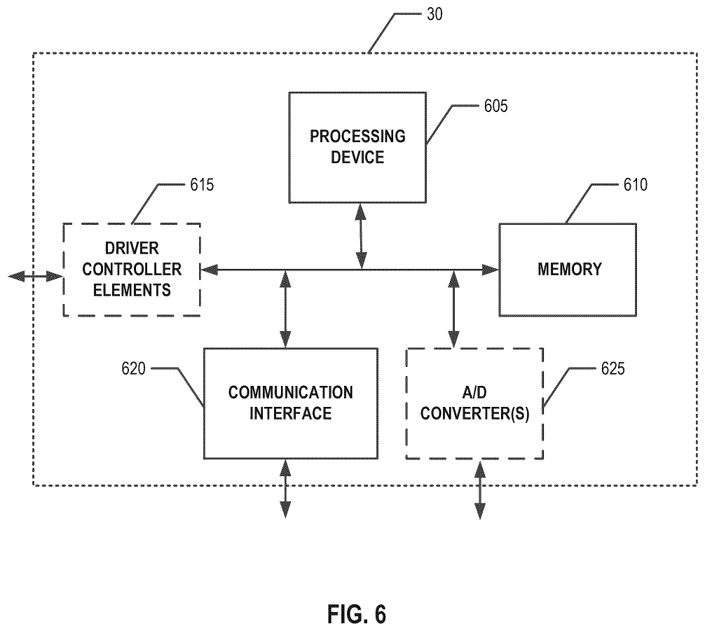

In various embodiments, the quantum computer 110 comprises an optics collection system 80 configured to collect and/or detect photons (e.g., stimulated emission) generated by qubit quantum objects disposed in respective locations (e.g., during reading/detection operations) defined at least in part by the confinement apparatus. The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubit quantum objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 625 (see FIG. 6) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more qubit quantum objects within the confinement apparatus, and/or read and/or detect a quantum (e.g., qubit) state of one or more qubit quantum objects within the confinement apparatus 200. For example, the controller 30 may cause a controlled evolution of quantum states of one or more qubit quantum objects within the confinement apparatus to execute a quantum circuit and/or algorithm. For example, the controller 30 may read and/or detect quantum states of one or more qubit quantum objects within the confinement apparatus at one or more points during the execution of a quantum circuit. In various embodiments, the qubit quantum objects confined by the confinement apparatus are used as qubits of the quantum computer 110.

### Example Qubit Quantum Object Confinement Apparatus

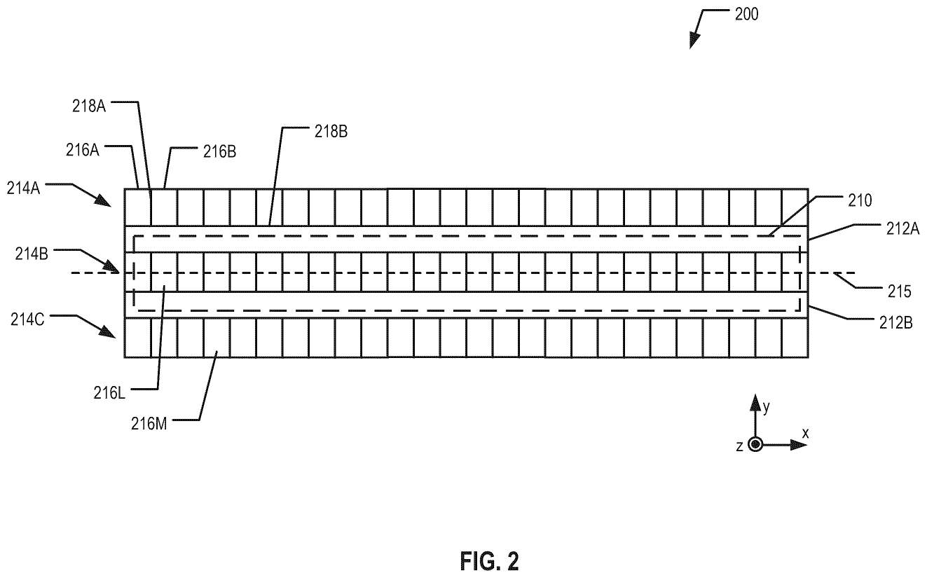

FIG. 2 provides a top view of at least a portion of an example confinement apparatus 200 that may be used to confine one or more qubit quantum objects. For example, in the illustrated embodiment, the confinement apparatus is an ion trap (e.g., a surface ion trap) and the qubit quantum objects are ions and/or ion crystals. The linear portion of the example confinement apparatus 200 may be part of a larger linear geometry of the confinement apparatus or may be part of a two-dimensional or three-dimensional geometry of the confinement apparatus, in various embodiments.

In an example embodiment, the confinement apparatus 200 (e.g., surface ion trap) is fabricated as part of an ion trap chip and/or part of an ion trap apparatus and/or package. In an example embodiment, the confinement apparatus 200 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 200 is at least partially defined by a number of sequences of control electrodes 214 (e.g., 214A, 214B, 214C). Each sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application.

In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 200 is a surface Paul trap with symmetric RF electrodes 212. In various embodiments, the RF electrodes 212 and the control electrodes 216 generate potentials and/or fields that are experienced by qubit quantum objects within respective confinement regions of the confinement apparatus 200. In particular, the RF electrodes 212 may be configured to define the respective confinement regions 210 of the confinement apparatus 200 and the control electrodes 216 may be configured to at least partially control movement and/or motion of qubit quantum objects within the respective confinement regions.

A gap 218A is disposed between adjacent control electrodes 216. For example, control electrodes 216A, 216B are adjacent electrodes as the control electrodes 216A, 216B are separated only by the gap 218A (e.g., there are no other electrodes between the adjacent control electrodes 216A, 216B). In various embodiments, a control electrode 216 and an adjacent RF electrode 212 are separated by a gap 218B.

### Example Optical Heterojunction Window

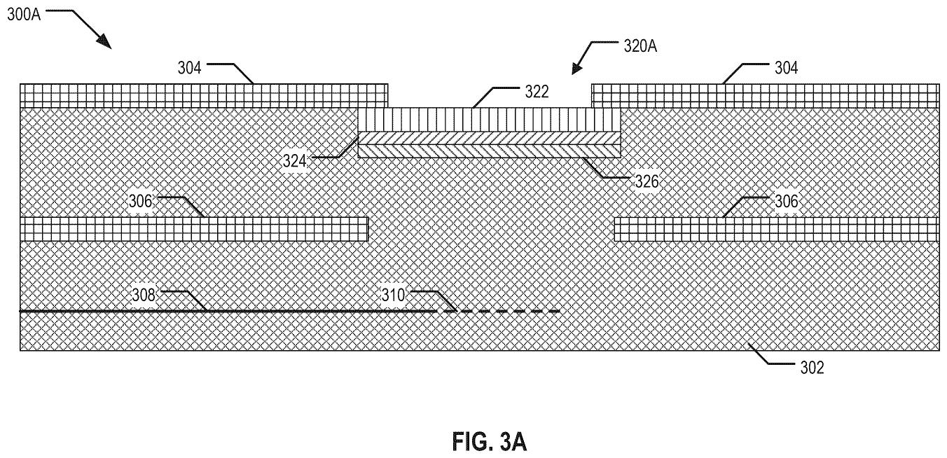

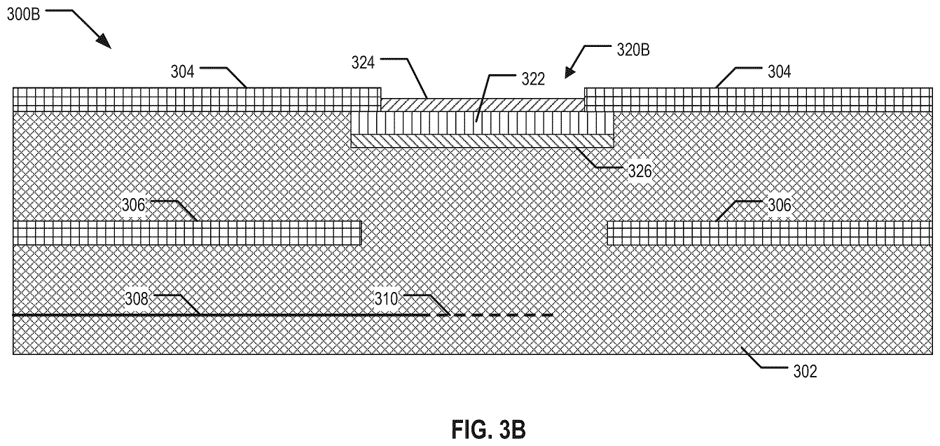

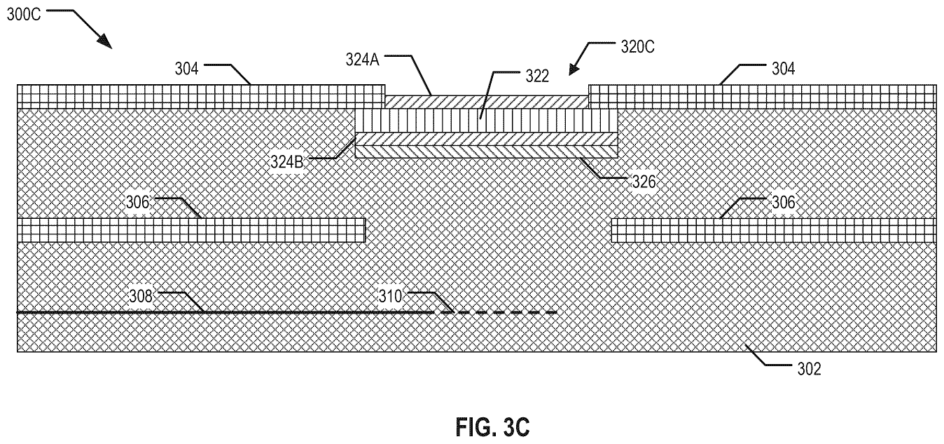

FIGS. 3A, 3B, and 3C illustrate cross-sections of at least a portion of an example qubit quantum object confinement apparatus having an optical heterojunction window, in accordance with various embodiments. FIGS. 3A, 3B, and 3C each illustrate a cross-sectional view of a portion of an example embodiment of, respectively, a qubit quantum object confinement apparatus 300A, 300B, 300C. Each example qubit quantum object confinement apparatus 300A, 300B, 300C comprises a substrates 302, a surface electrode 304 having a gap therein, and one or more metal sub-layers 306 (such as aluminum, aluminum-silicon-copper, platinum, gold, or titanium), and an optical heterojunction window (described below) spanning the gap in the surface electrode 304.

Each of the qubit quantum object confinement apparatuses 300A, 300B, 300C includes one or more integrated photonics layers that each include one or more respective photonic elements. For example, the illustrated integrated photonics layer includes photonic components such as a waveguide 308 and a coupler 310. In various embodiments, the coupler 310 is aligned with the window such that the coupler 310 couples light out of the waveguide 308 and out through the window. In an example embodiment, the coupler 310 is configured to couple light that passed through the window into the waveguide 308.

Each example qubit quantum object confinement apparatus 300A, 300B, 300C of, respectively, FIGS. 3A, 3B, and 3C illustrates an example optical heterojunction window in accordance with alternative embodiments of the present disclosure. As seen in FIGS. 3A, 3B, and 3C, the example optical heterojunction windows span the opening in the surface electrode 304.

FIG. 3A illustrates what may be termed an asymmetric optical heterojunction window 320A comprising a transparent conductive layer (TCL) 322, a cladding layer 324 on one side of the TCL 322, and an anti-reflective layer stack 326 on the cladding layer 324. In various embodiments, the anti-reflective layer stack may be omitted. In various embodiments, the asymmetric optical heterojunction window 320A is conductive and transparent for at least a selected range of frequencies of light. In various embodiments, the cladding layer 324 has a larger effective band gap and a lower relative permittivity than that of the TCL 322.

FIG. 3B illustrates another embodiment of what may be termed an asymmetric optical heterojunction window 320B comprising a TCL 322, a cladding layer 324 on one side of the TCL 322, and an anti-reflective layer stack 326 on the opposite side of the TCL 322. In various embodiments, the anti-reflective layer stack may be omitted. In various embodiments, the optical heterojunction window 320B is conductive and transparent for at least a selected range of frequencies of light. In various embodiments, the cladding layer 324 has a larger effective band gap and a lower relative permittivity than that of the TCL 322.

FIG. 3C illustrates what may be termed a symmetric optical heterojunction window 320C comprising a TCL 322, a first cladding layer 324A on one side of the TCL 322, a second cladding layer 324B on the opposite side of the TCL 322, and an anti-reflective layer stack 326 on the opposite side of the second cladding layer 324B from the TCL 322. In various embodiments, the anti-reflective layer stack may be omitted. In various embodiments, the optical heterojunction window 320C is conductive and transparent for at least a selected range of frequencies of light. In various embodiments, the first cladding layer 324A and the second cladding layer 324B each have a larger effective band gap and a lower relative permittivity than that of the TCL 322.

Although not illustrated, in various embodiments, a conductive transparent window may comprise a TCL and an anti-reflective layer stack, and the cladding layer(s) may be omitted.

In various embodiments, the materials and thicknesses of the cladding layer(s) and the anti-reflective layer stack are co-designed with the goal of both maximizing the electrical properties as well as the optical transmission. In various embodiments, the thickness of the cladding layer(s) of such optical heterojunction windows as shown in FIGS. 3A, 3B, and 3C is much less than the thickness of the TCL. For example, in various embodiments, the thickness of each TCL is at least ten times the thickness of its corresponding cladding layer. In one specific example, for an optical heterojunction window in which the TCL is about 20 nanometers (nm) thick, the cladding layer should be about one to a few nm thick. In various embodiments, the TCL of such optical heterojunction window as shown in FIGS. 3A, 3B and 3C comprises any suitable transparent conductive oxide, such as Indium tin oxide (ITO) or Aluminum-doped zinc oxide (AZO). In various embodiments, the cladding layer(s) of such optical heterojunction window as shown in FIGS. 3A, 3B and 3C comprises any suitable material, such as one or more of niobium (Nb), indium tin oxide (ITO), aluminum zinc oxide (AZO), indium oxide (In₂O₃), titanium nitride (TiN), tantalum nitride (TaN), gold (Au), or platinum (Pt). In various embodiments, the anti-reflective (AR) coating of such optical heterojunction window as shown in FIGS. 3A, 3B and 3C comprise two or more other dielectrics or some kind of films, such as silicon nitride or silicon dioxide.

In various embodiments, the refractive index, film thickness, and number of layers comprising the AR coating are chosen to design for a target range of wavelengths and incident angles from the output grating coupler and may be different depending on which window they are applied to on an ion trap. The salient feature of the materials selected for the AR layer stack is their index of refraction The refractive index is determined by the film species. The index of refraction of the materials is set (i.e., it is a property of the material), so the way that you change the index of refraction of the AR layers stack is by choosing different materials and/or different thicknesses. In various embodiments, the AR layer stack is optimized (maximize optical transmission/minimize reflected power) by measuring the reflected power of selected materials at different polarizations and frequencies and at different thicknesses of the AR layers.

Optical heterojunction windows of various embodiments may be used in any suitable component, device, apparatus, system, etc. For example, in various embodiments, an optical heterojunction window as described herein may form an edge perimeter around a confinement apparatus (e.g., an ion trap), which, among other things, allows for glancing free-space beam delivery with a clean edge for such confinement apparatuses.

Optical heterojunction windows of various embodiments are described herein relative to their use in atom/ion trap chips. However, optical heterojunction windows of various embodiments may be used in any suitable type of chip, such as, but not limited to ancillary delivery, bridge, cloud, or external chips. As used herein, an ancillary chip refers to any distinct chip (relative to the confinement apparatus chip) that includes co-integrated photonics-electronics (as described herein) configured to interface with a confinement apparatus chip.

In various embodiments, a confinement apparatus chip defines an apparatus plane. In various embodiments, the confinement apparatus system comprises one or more bridge chips that each define a respective bridge plane. The respective bridge planes are coplanar with the apparatus plane. Each of the one or more bridge chips may have one or more optical elements disposed and/or formed thereon and/or therein. In various embodiments, a bridge chip comprises zero or more inputs and one or more outputs. In various embodiments, a bridge chip is configured to provide manipulation signals and/or other optical signals to one or more optical elements disposed on the confinement apparatus chip, the bridge chip, and/or other chips (e.g., cloud chip, external chip, or the like). In various embodiments, a bridge chip may span regions that involve varying temperatures and/or pressures (e.g., within a cryogenic and/or vacuum chamber within which the confinement apparatus chip is disposed).

In various embodiments, a delivery chip may be disposed within the cryogenic and/or vacuum chamber within which the confinement apparatus chip is disposed or external thereto. In various embodiments, delivery chips may be configured in various physical orientations. For example, a delivery chip defines a delivery chip plane which may be disposed with various orientations with respect to the apparatus plane. For example, in an example embodiment, a delivery chip is mounted to a wall and/or shielding surface of the cryogenic and/or vacuum chamber within which the confinement apparatus chip is disposed. An example of a delivery chip is a cloud chip. In various embodiments, the confinement apparatus system comprises one or more cloud chips that each define a respective cloud plane that is parallel to the apparatus plane but not coplanar with the apparatus plane. Each of the one or more cloud chips may have one or more optical elements disposed and/or formed thereon and/or therein. In various embodiments, the confinement apparatus system comprises one or more external chips (e.g., one or more photonic integrated circuits (PICs)).

As described above, the AR layer stack is co-designed with the TCL and cladding (if present) with the goal of both maximizing the electrical properties as well as the optical transmission.

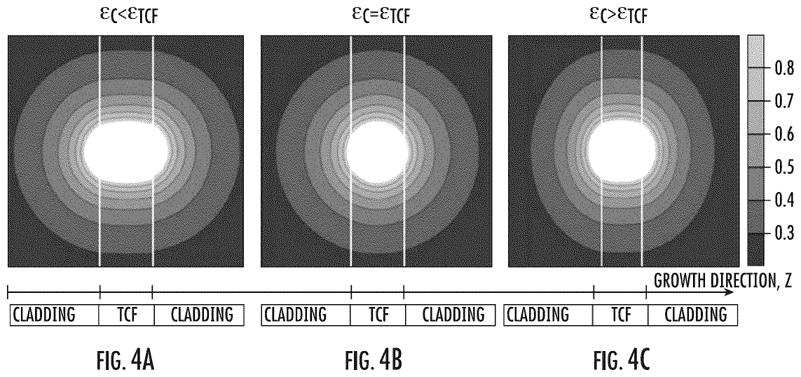

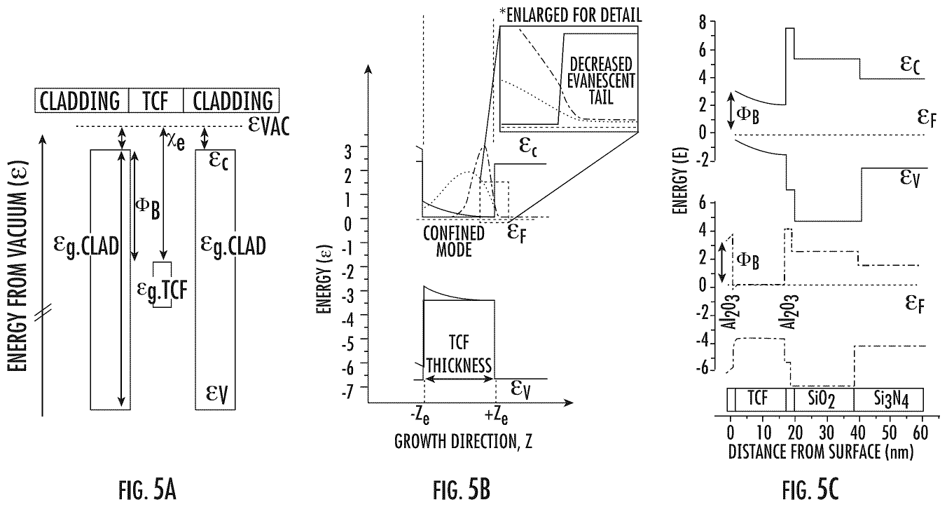

FIGS. 4A-C illustrate the potential energy in a material if one charge was placed in that material and it was clad by some other material that was characterized by a different relative permittivity. In FIGS. 4A-C, the X axis scale is dimensionality in the growth direction (i.e., taking a cross sectional slice across an example electrically conductive and optically transparent window (which may also be termed a transparent conductive window) of embodiments of the present disclosure comprising a TCL clad on both sides (indicated by the blocks below each of FIGS. 4A-C)) and the Y axis is dimensionality in the in-plane direction. The color gradient indicates the potential energy gradient due to the interior change. FIGS. 4A-C illustrate ITO as the TCL, which as a potential band gap of 3.5, and how the potential of a charge placed in the TCL spreads out from the charge. FIGS. 4A-C illustrate three different scenarios: FIG. 4A illustrates a scenario in which the relative permittivity of the cladding (ε_{C}) is less than that of the TCL (ε_{TCL}); FIG. 4B illustrates a scenario in which the relative permittivity of the cladding is equal to that of the TCL (i.e., where the cladding is the TCL material); and FIG. 4C illustrates a scenario in which the relative permittivity of the cladding is greater than that of the TCL. As seen in FIG. 4C, the potential gets squeezed when you have a higher permittivity cladding layer. As such, in various embodiments it is desirable to have a higher permittivity cladding layer because the potential due to that charge is more confined to the TCL.

FIG. 5A illustrates a band gap lineup of an example electrically conductive and optically transparent window of embodiments of the present disclosure comprising a TCL clad on both sides in which the X axis scale is dimensionality (i.e., taking a cross sectional slice across the example electrically conductive and optically transparent window (indicated by the block above of FIG. 5A)) and the Y axis is energy (ε). In FIG. 5A, ε_{vac} is the energy of the vacuum background; εᵥ is the valence band energy of the respective material; ε_{g,TCL} TCL is the energy band gap of the transparent conductive layer; ε_{g,clad} is the energy band gap of the cladding material/layer; xₑ is electron affinity, which is the energy of electrons in the material relative the energy of the background vacuum; and Φ_{B} is the work function or energy of the barrier, typically taken as the difference in conduction band energy of adjacent materials or the difference between vacuum energy and conduction band energy of a material. FIG. 5A illustrates that a desirable choice for electronic confinement of the conduction mode in the TCL would be where you choose a cladding material with a band gap that is larger than that of TCL (shown by relative large size of ε_{g,clad} versus ε_{g,TCL}) and also provides an energy barrier to the TCL (shown by the offset Φ_{B}).

FIG. 5B illustrates a band gap lineup of an example electrically conductive and optically transparent window of embodiments of the present disclosure comprising a TCL clad on both sides in which the X axis scale is dimensionality (i.e., taking a cross sectional slice across the example electrically conductive and optically transparent window (indicated by the block above FIG. 5B)) and the Y axis is energy (ε). In the example of FIG. 5B, the TCL is ITO and the cladding is aluminum oxide. In FIG. 5B, εᵥ is the valence band energy; ε_{F} is the Fermi level energy; ε_{c} is the conduction band energy; z is the growth direction of the window in which the TCL spans from −zₑ to +zₑ. The solid line curve and the dashed line curve in FIG. 5B illustrate the conduction mode through the example window. The solid line curve shows a conduction mode with an evanescent tail that permeates the cladding. In various embodiments, the goal is to squeeze the conduction mode such that that tail is reduced so that it does not permeate the cladding (or permeates less) the cladding. In FIG. 5B, the dashed line curve shows a conduction mode of the window with carefully selected cladding layers such that the evanescent tail is decreased and does not permeate the cladding as much, thereby providing increased conductivity with only a slight increase in thickness of the window (due to adding the cladding layers).

FIG. 5C illustrates a band gap lineup of an example electrically conductive and optically transparent window of embodiments of the present disclosure comprising, in the bottom example, a TCL clad on both sides and an AR layer stack, and, in the top example, a TCL clad on one side and an AR layer stack on the cladding. In FIG. 5C, the X axis scale is dimensionality (i.e., taking a cross sectional slice across the example electrically conductive and optically transparent window and the Y axis is energy (E). In the example of FIG. 5C, the TCL is ITO, the cladding is aluminum oxide, and the AR layer stack comprises silicon oxide and silicon nitride. In FIG. 5C, ε_{F} is the Fermi energy level; εᵥ is the valence band energy; ε_{c,TCL} is the energy band gap of the transparent conductive layer; and Φ_{B} is the work function or energy of the barrier. In FIG. 5C, the top example shows how asymmetry impacts the conduction mode. FIG. 5C shows two band diagrams of film stack variations that could manifest as a TCL/AR stack. The top image in FIG. 5C demonstrates the resultant energy band diagram for an asymmetrically-clad TCL window adjacent to the AR layers indicating band bending in the TCL due to the electrostatics of the asymmetry. The conduction mode shape and therefore the conductivity is affected by such band bending and is a design variable. The bottom image in FIG. 5C demonstrates the resultant energy band for a symmetrically-clad TCL window adjacent to the AR layers. In this symmetrically-clad scenario, the band bending in the TCL may be minimized depending on the electrostics of the vacuum-barrier interface and consequently will give rise to a symmetric conduction mode, which is also a variable for design.

### Technical Advantages

Because the exposed surfaces of TCL-based optical windows of qubit quantum object confinement apparatuses play a dominant role in the conductivity and resistivity of the optical windows, conventional methods for forming such optical windows involving the use of TCL requires surface treatments, patterning, etc., to provide the desired conductivity/resistivity.

Embodiments of the present disclosure provide technical solutions to these technical problems. Various embodiments provide electrically conductive and optically transparent windows, qubit quantum objection confinement apparatuses, systems comprising qubit quantum object confinement apparatuses, and/or methods for fabricating electrically conductive and optically transparent windows and qubit quantum object confinement apparatuses that provide for adding one or more cladding layers to the transparent conductive layer of electrically conductive and optically transparent windows. In this regard, conductivity/resistivity of the optical windows is improved without regard to surface treatments, patterning, etc.

Various embodiments therefore provide an improvement to the field of electrically conductive and optically transparent windows, confinement apparatuses, systems including confinement apparatuses, and methods for fabricating confinement apparatuses.

### Example Controller

Various embodiments provide systems comprising confinement apparatus 300. For example, various atomic systems, quantum systems, and/or the like may use a confinement apparatus 300 to confine one or more qubit quantum objects. In an example embodiment, the system is a quantum charge-coupled device (QCCD-based) quantum computer 110 or other quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more qubit quantum objects confined by the confinement apparatus, and/or read and/or detect a quantum state of one or more qubit quantum objects confined by the confinement apparatus.

As shown in FIG. 6, in various embodiments, the controller 30 may comprise various controller elements including one or more processing devices 605, memory 610, driver controller elements 615, a communication interface 620, analog-digital converter elements 625, and/or the like. For example, the one or more processing devices 605 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 605 of the controller 30 comprises a clock and/or is in communication with a clock. In various embodiments, this clock defines the clock cycles of the system.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 110 (e.g., voltage sources 50, manipulation sources 64, magnetic field sources 70, and/or the like) to cause a controlled evolution of quantum states of one or more qubit quantum objects, detect and/or read the quantum state of one or more qubit quantum objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to the electrodes (e.g., the RF, control, and/or other electrodes of the confinement apparatus 300) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes 342 (e.g., control electrodes 216 and/or RF electrodes 212). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 625 configured to receive signals from one or more detectors, optical receiver components, calibration sensors, and/or the like.

In various embodiments, the controller 30 may comprise a communication interface 620 for interfacing and/or communicating with one or more computing entities 10. For example, the controller 30 may comprise a communication interface 620 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

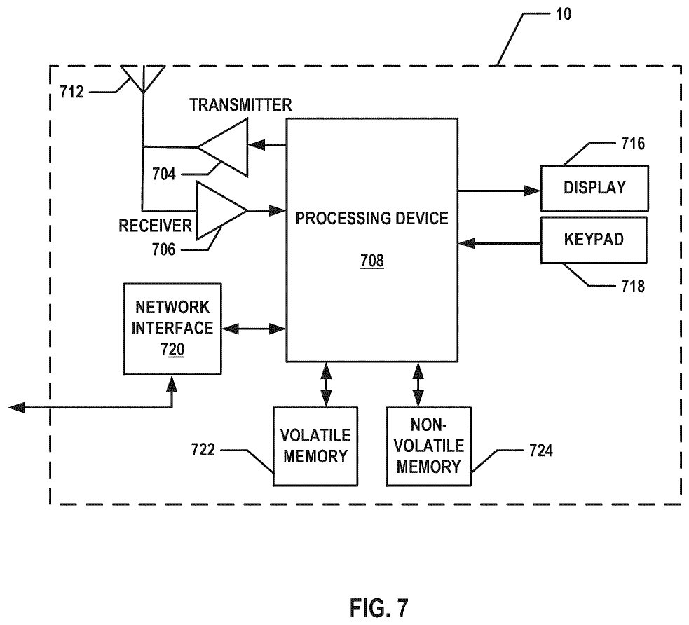

FIG. 7 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 6, a computing entity 10 can include an antenna 712, a transmitter 704 (e.g., radio), a receiver 706 (e.g., radio), and a processing device 708 that provides signals to and receives signals from the transmitter 704 and receiver 706, respectively.

The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 720 configured to communicate via one or more wired and/or wireless networks 20.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An electrically conductive and optically transparent window comprising:
a transparent conductive layer (TCL); and
a first cladding layer applied to the TCL;
wherein a material and a thickness of the first cladding layer are selected to increase the conductivity of the window as compared to an electrically conductive and optically transparent window comprising the TCL without a cladding layer.

2. The window of claim 1, further comprising an antireflective layer stack;
wherein a number of layers, a material of each layer, and a thickness of each layer of the antireflective layer stack are selected to balance high optical transmission and low reflected power.

3. The window of claim 2, wherein the antireflective layer stack is applied to the TCL opposite the first cladding layer.

4. The window of claim 2, wherein the antireflective layer stack is applied to the first cladding layer opposite the TCL.

5. The window of claim 4, further comprising a second cladding layer applied to the TCL opposite the first cladding layer;
wherein a material and a thickness of the second cladding layer are selected to increase the conductivity of the window as compared to an electrically conductive and optically transparent window comprising the TCL and the first cladding layer without a second cladding layer.

6. The window of claim 1, wherein the first cladding layer has a higher relative permittivity than a permittivity of the TCL.

7. The window of claim 1, wherein an effective bandgap of the first cladding layer is larger than an effective bandgap of the TCL such that an electronic mode confinement is created by the first cladding layer at an interface between the first cladding layer and the TCL.

8. A qubit quantum object confinement apparatus comprising:
a substrate;
a plurality of electrodes disposed on a surface of the substrate; and
at least one electrically conductive and optically transparent window spanning an opening defined in a corresponding one of the plurality of electrodes;
wherein the at least one electrically conductive and optically transparent window comprises a transparent conductive layer (TCL) and a first cladding layer applied to the TCL; and
wherein a material and a thickness of the first cladding layer are selected to increase the conductivity of the window as compared to an electrically conductive and optically transparent window comprising the TCL without a cladding layer.

9. The qubit quantum object confinement apparatus of claim 8, wherein the at least one electrically conductive and optically transparent window further comprises an antireflective layer stack; and
wherein a number of layers, a material of each layer, and a thickness of each layer of the antireflective layer stack are selected to balance high optical transmission and low reflected power.

10. The qubit quantum object confinement apparatus of claim 9, wherein the antireflective layer stack is applied to the TCL opposite the first cladding layer.

11. The qubit quantum object confinement apparatus of claim 9, wherein the antireflective layer stack is applied to the first cladding layer opposite the TCL.

12. The qubit quantum object confinement apparatus of claim 11, wherein the at least one electrically conductive and optically transparent window further comprises a second cladding layer applied to the TCL opposite the first cladding layer; and
wherein a material and a thickness of the second cladding layer are selected to increase the conductivity of the window as compared to an electrically conductive and optically transparent window comprising the TCL and the first cladding layer without a second cladding layer.

13. The qubit quantum object confinement apparatus of claim 9, wherein the first cladding layer has a higher relative permittivity than a permittivity of the TCL.

14. The qubit quantum object confinement apparatus of claim 9, wherein an effective bandgap of the first cladding layer is larger than an effective bandgap of the TCL such that an electronic mode confinement is created by the first cladding layer at an interface between the first cladding layer and the TCL.

15. A quantum computer comprising:
a qubit quantum object confinement apparatus comprising:
a substrate;
a plurality of electrodes disposed on a surface of the substrate; and
at least one electrically conductive and optically transparent window spanning an opening defined in a corresponding one of the plurality of electrodes;
at least one manipulation source configured to provide a manipulation signal; and
a controller configured to control operation of the qubit quantum object confinement apparatus to cause the qubit quantum object confinement apparatus to confine one or more qubit quantum objects, the controller further configured to control operation of the at least one manipulation source to cause the manipulation signal to be incident on a qubit quantum object of the one or more qubit quantum objects via the at least one electrically conductive and optically transparent window;
wherein the at least one electrically conductive and optically transparent window comprises a transparent conductive layer (TCL) and a first cladding layer applied to the TCL; and
wherein a material and a thickness of the first cladding layer are selected to increase the conductivity of the window as compared to an electrically conductive and optically transparent window comprising the TCL without a cladding layer.

16. The qubit quantum object confinement apparatus of claim 15, wherein the at least one electrically conductive and optically transparent window further comprises an antireflective layer stack; and
wherein a number of layers, a material of each layer, and a thickness of each layer of the antireflective layer stack are selected to balance high optical transmission and low reflected power.

17. The qubit quantum object confinement apparatus of claim 16, wherein the antireflective layer stack is applied to the TCL opposite the first cladding layer or the antireflective layer stack is applied to the first cladding layer opposite the TCL.

18. The qubit quantum object confinement apparatus of claim 17, wherein the at least one electrically conductive and optically transparent window further comprises a second cladding layer applied to the TCL opposite the first cladding layer; and
wherein a material and a thickness of the second cladding layer are selected to increase the conductivity of the window as compared to an electrically conductive and optically transparent window comprising the TCL and the first cladding layer without a second cladding layer.

19. The qubit quantum object confinement apparatus of claim 15, wherein the first cladding layer has a higher relative permittivity than a permittivity of the TCL.

20. The qubit quantum object confinement apparatus of claim 15, wherein an effective bandgap of the first cladding layer is larger than an effective bandgap of the TCL such that an electronic mode confinement is created by the first cladding layer at an interface between the first cladding layer and the TCL.
